(19) United States
(12) Patent Application Publication
(10) Pub. No.: US 2024/0313427 A1
(43) Pub. Date: Sep. 19, 2024

(54) ANTENNA AND COMMUNICATION SYSTEM

(71) Applicant: Huawei Technologies Co., Ltd., Shenzhen (CN)

(72) Inventors: Bojie Li, Shanghai (CN); Zhi Gong, Dongguan (CN); Weihong Xiao, Dongguan (CN); Guanxi Zhang, Shanghai (CN); Di Wang, Shanghai (CN); Xianghua Li, Shanghai (CN)

(21) Appl. No.: 18/668,801

(22) Filed: May 20, 2024

Related U.S. Application Data
(63) Continuation of application No. PCT/CN2022/132991, filed on Nov. 18, 2022.

(30) Foreign Application Priority Data
Nov. 21, 2021 (CN) 202111381535.4

(51) Int. Cl. H01Q 21/24; H01Q 1/20; H01Q 1/24

(52) U.S. Cl. CPC H01Q 21/24; H01Q 1/20; H01Q 1/246

(57) ABSTRACT

This application provides an antenna and a communication system. The antenna includes a front mounting surface, a side mounting surface, a front radiating element array, and a side radiating element array. The front radiating element array is mounted on the front mounting surface, and the side radiating element array is mounted on the side mounting surface. An included angle on a side away from the front radiating element array is a first included angle, and the first included angle is less than 180°. One end of a circuit module is connected to an antenna port connected to the front radiating element array and an antenna port connected to the side radiating element array, and another end of the circuit module is configured to connect to radio frequency ports.

### CROSS-REFERENCE TO RELATED APPLICATIONS

This application is a continuation of International Application No. PCT/CN2022/132991, filed on Nov. 18, 2022, which claims priority to Chinese Patent Application No. 202111381535.4, filed on Nov. 21, 2021. The disclosures of the aforementioned applications are hereby incorporated by reference in their entireties.

### TECHNICAL FIELD

This application relates to the field of communication technologies, and specifically, to an antenna and a communication system.

### BACKGROUND

With development of wireless communication technologies, a communication system can support increasingly more communication frequency bands. Therefore, a structure of an antenna of the communication system is increasingly complex, and an antenna integration level is also increasingly high. Due to limitations of conditions such as wind load, it is difficult to further increase a front size of the antenna. As a result, a quantity of radiating elements integrated into the antenna is small, and strength and a range of a signal that may be radiated are also limited, making it difficult to improve performance of the communication system.

### SUMMARY

This application provides an antenna and a communication system, to improve coverage of the antenna and improve performance of the antenna without increasing wind load and mounting space of the antenna.

According to a first aspect, this application provides an antenna. The antenna includes a front mounting surface, a side mounting surface, radiating element arrays, and a circuit module. The radiating element arrays include a front radiating element array and a side radiating element array. The front radiating element array is mounted on the front mounting surface, and the side radiating element array is mounted on the side mounting surface. It may be understood that the front mounting surface is a surface used to mount the front radiating element array, and the side mounting surface is a surface used to mount the side radiating element array. In included angles between the front mounting surface and the side mounting surface, an included angle on a side away from the front radiating element array and the side radiating element array is a first included angle, and an angle of the first included angle is less than 180°. In other words, the front mounting surface and the side mounting surface are not located on a same plane, but are located on two different planes that form the first included angle. Therefore, an area of a projection of the radiating element array of the antenna on a plane on which the front mounting surface is located is reduced. This helps reduce wind load of the antenna. Alternatively, when wind load is fixed, in this embodiment of this application, a larger quantity of radiating element arrays may be disposed, so that coverage of the antenna can be improved, and performance of the antenna can be improved.

In an optional implementation, the angle of the first included angle may be less than or equal to 90°. In this solution, the wind load of the antenna can be reduced to a great extent. In addition, a coverage effect of a radiated signal in a back side area of a front radiating element can be well considered.

When the antenna is disposed, in an optional manner, the antenna may further include a front mounting plate and a side mounting plate. The front mounting surface is located on the front mounting plate, and the side mounting surface is located on the side mounting plate. In this solution, the front radiating element array and the side radiating element array may be directly mounted on the front mounting plate and the side mounting plate.

The front mounting plate includes a reflecting plate, and the side mounting plate includes a reflecting plate. For example, the front mounting plate and the side mounting plate may be of structures made of a metal material or the like, and used as reflecting plates; or surfaces of the front mounting plate and the side mounting plate may be coated to prepare reflecting plates. This is not limited in this application.

At least a part of an orthographic projection of the side radiating element array on the front mounting plate is on the front mounting plate. In this solution, the front mounting plate may be used to separate the front radiating element array and the side radiating element array, to reduce crosstalk between the front radiating element array and the side radiating element array.

It may be understood that, in some technical solutions, the orthographic projection of the side radiating element array on the front mounting plate may not be on the front mounting plate at all. This helps reduce the wind load of the antenna.

Specifically, when the front mounting plate is designed, an edge of the front mounting plate may have a first folding portion, and the first folding portion is located on a side of the front mounting plate on which the front radiating element array is mounted. In this solution, strength of a signal radiated from the back of the front mounting plate by the antenna can be reduced, and a front-to-back ratio of the antenna can be increased.

Alternatively, an edge of the side mounting plate may have a second folding portion, and the second folding portion is located on a side of the side mounting plate on which the side radiating element array is mounted. In this solution, strength of a signal radiated from the back of the side mounting plate by the antenna can be reduced, and a front-to-back ratio of the antenna can be increased.

In a specific implementation, only the front mounting plate may have the first folding portion, or only the side mounting plate may have the second folding portion, or the front mounting plate may have the first folding portion, and the side mounting plate may have the second folding portion. This may be designed based on an actual requirement.

To mount the antenna, the antenna further includes a mounting kit. The mounting kit is disposed on a side that is of the front mounting surface and that is away from the front radiating element array. The mounting kit has a connector. The connector is configured to connect to a pole. A distance between the connector and the front mounting surface is greater than a distance between any position of the side mounting surface and the front mounting surface. The connector is located on outer sides of all front mounting surfaces and side mounting surfaces, so that a plurality of antennas can be mounted on a same pole, to reduce space occupied by the antennas. In addition, the front mounting surface and the side mounting surface of the antenna may be disposed in one radome, and radiating element arrays in the radome are mounted on the pole as a whole.

In an optional technical solution, the antenna may include one front mounting surface and two side mounting surfaces. The two side mounting surfaces are respectively disposed on two opposite side surfaces of the front mounting surface. The front radiating element array is disposed on the front mounting surface, and the side radiating element array is disposed on the side radiating surface. In this solution, side radiating element arrays are disposed on two sides of the front radiating element array. In this solution, the performance of the antenna can be improved to a great extent while it is ensured that space occupied by the front mounting surface of the antenna is fixed.

Specifically, the two side mounting surfaces include a first side mounting surface and a second side mounting surface. m columns of front radiating element arrays are disposed on the front mounting surface. n columns of side radiating element arrays are disposed on the first side radiating surface. s columns of side radiating element arrays are disposed on the second side radiating surface. m, n, and s satisfy that m:n:s=a:b:a, where both a and b are integers greater than 0, and b>a. A quantity of side radiating element arrays is less than a quantity of front radiating element arrays, and sizes of the side mounting surfaces on two sides are small. This helps reduce a thickness of the antenna and reduce a section of the antenna.

In a specific technical solution, it may be assumed that b=2 and a=1. This solution facilitates power sharing by using a bridge.

The circuit module specifically includes a bridge. The bridge includes an input port and an output port. The input port is connected to a radio frequency port. The output port of the bridge is separately connected to the front radiating element array and the side radiating element array. Power sharing between the front radiating element array and the side radiating element array can be implemented by using the bridge, so that the entire antenna can operate as a whole.

The antenna may be an active antenna or a passive antenna. When the antenna is an active antenna, the antenna includes a radio frequency board and a heat sink. The heat sink is disposed on a side that is of the radio frequency board and that is away from the front mounting surface. The front radiating element array and the side radiating element array are connected to the radio frequency board. One radio frequency board is connected to all the radiating element arrays. This helps simplify a structure of the antenna, and facilitates calibration and collaboration between different radiating element arrays.

Certainly, in another optional technical solution, the antenna may alternatively include one front mounting surface and one side mounting surface. In this case, the side radiating element array is disposed only on one side of the front radiating element array, to improve signal strength and signal coverage on the side.

The antenna may be an active antenna or a passive antenna. This is not limited in this application.

In an optional technical solution, the front radiating element array may be further connected to an antenna port. The side radiating element array is also connected to an antenna port. One end of the circuit module is connected to the antenna port connected to the front radiating element array and the antenna port connected to the side radiating element array, and another end of the circuit module is configured to connect to radio frequency ports. In this solution, the circuit module enables the front radiating element array and the side radiating element array to be connected to a same drive end, so that both the front radiating element array and the side radiating element array can be driven.

The radio frequency port varies in different types of antennas. For example, when the antenna is an active antenna, the radio frequency port is a port corresponding to a radio frequency module of the active antenna; or when the antenna is a passive module, the radio frequency port is a radio frequency port of a remote radio unit.

In another optional technical solution, at least one antenna port is electrically connected to at least two of the plurality of radio frequency ports through the circuit module. In this solution, the circuit module may be used to reallocate power input by the radio frequency port, to implement power sharing between subarrays of the antenna. Therefore, in this solution, input power of the antenna port can be allocated based on an actual requirement, and coverage of a signal radiated by the antenna and a channel capacity can be adjusted.

In still another optional technical solution, any antenna port may be electrically connected to any one of the plurality of radio frequency ports through the circuit module. In this case, power input by each radio frequency port may be transmitted to any antenna port, to implement power reallocation. Therefore, coverage of a signal radiated by the antenna can be adjusted based on a requirement, and a channel capacity in a specified range can be increased.

The antenna may further include a first calibration module. The first calibration module is configured to calibrate phases and amplitudes between different antenna ports. This solution facilitates collaboration between the antenna ports, to obtain a required beamforming pattern, so as to improve the performance of the antenna.

In an optional implementation, the first calibration module includes a coupler and a power splitter.

In a specific technical solution, the antenna port connected to the front radiating element array is connected to a coupler, and the antenna port connected to the side radiating element array is also connected to a coupler. The coupler is connected to a calibration port through the power splitter. All couplers connected to each antenna may be connected to one power splitter, so that signals of all the radiating element arrays are converged.

The radiating element array may include a plurality of radiating elements. Each radiating element is connected to an active component. The active component is configured to reconstruct a pattern of the radiating element. In this solution, based on an actual requirement, the pattern of the corresponding radiating element can be adjusted by using the active component, to change a direction of maximum radiation of the antenna. The antenna may include a plurality of radiating element arrays. Each radiating element array may include a plurality of radiating elements. A pattern of the radiating element is adjusted by using an active component, so that a pattern of the radiating element array can be adjusted, to increase a degree of freedom in adjusting a pattern of the entire antenna, and implement 360° coverage of a signal radiated by a single antenna.

A specific type of the active component is not limited. For example, the active component may be at least one of a diode, a capacitance tube, a varactor, a radio frequency microelectromechanical system (MEMS) switch, a liquid crystal, graphene, and a micro-mechanical rotating apparatus. This is not specifically limited in this application.

According to a second aspect, this application further provides a communication system. The communication system includes a mounting bracket and the antenna according to the first aspect. The antenna is mounted on the mounting bracket. A radiation range of the antenna in the communication system is wide. This helps improve coverage and signal strength of the communication system. Specifically, at fixed signal strength, a quantity of antennas disposed may be reduced, to reduce costs. When a quantity of antennas mounted in the communication system is fixed, the signal strength of the communication system may be high.

A quantity of antennas included in each communication system is not limited, and a networking form that may be implemented is not limited either.

For example, the communication system may include one antenna, and a signal radiated by the antenna covers one cell. The antenna can implement 360° coverage of the radiated signal, and the communication system can implement full coverage by using one antenna. This helps reduce costs of the communication system.

In addition, when the communication system includes one antenna, the antenna includes one front mounting surface and two side mounting surfaces. The two side mounting surfaces are respectively disposed on two opposite side surfaces of the front mounting surface. A front radiating element array is disposed on the front mounting surface. Side radiating element arrays include a first side radiating element array and a second side radiating element array. The first side radiating element array is disposed on one of the two side radiating surfaces. The second side radiating element array is disposed on the other of the two side radiating surfaces. In this technical solution, a signal radiated by the front radiating element array may cover a first cell, a signal radiated by the second side radiating element array may cover a second cell, and a signal radiated by a third side radiating element array may cover a third cell. In other words, one antenna may be used to implement signal coverage of three cells, to reduce energy consumption of the communication system.

In an optional implementation, at least two antennas are included. Different antennas can also perform collaborative operation.

To implement collaboration between different antennas, a second calibration module is connected between two adjacent antennas, and the second calibration module is configured to calibrate phases and amplitudes between the different antennas. In this way, all antenna panels of the entire communication system may perform collaborative operation based on a requirement.

Front radiating element arrays mounted on a front mounting surface of each antenna form one antenna panel. Side radiating element arrays mounted on each side mounting surface also form one antenna panel. The communication system includes a plurality of radiation areas. At least one of the radiation areas is covered by beams radiated by antenna panels of at least two different antennas. In this solution, a coverage area of the antenna can be adjusted based on a requirement, to enrich application scenarios of the antenna.

In another specific embodiment, the communication system includes at least two radiation areas, and the radiation areas are in one-to-one correspondence with the antennas. The antennas may not collaborate with each other, but only a plurality of antenna arrays inside the antenna collaborate with each other.

Both the front radiating element array and the side radiating element array are radiating element arrays. The communication system includes a plurality of radiating element arrays. A first radiating element array is used as a baseline. A phase of an i^{th} radiating element array is obtained based on coordinates of the first radiating element array, coordinates of the i^{th} radiating element array, an included angle between a direction of the i^{th} radiating element array and an x-axis, and a phase of the first radiating element array.

In addition, the communication system may include two or more antennas. For example, the communication system may include three antennas, where the three antennas are a first antenna, a second antenna, and a third antenna. In this case, collaborative operation between different antennas can be implemented by using a collaborative algorithm. Power sharing and channel sharing between the antennas can be further implemented through cooperation with a circuit module.

In an optional networking form, signals radiated by the foregoing three antennas may cover a same cell. In this solution, coverage of a signal radiated by each antenna may be greater than 120°, to ensure signal strength of an area corresponding to a gap between two adjacent antennas. In this solution, one or two of the antennas may be further disabled based on a requirement, to implement energy saving of the communication system.

In another optional networking form, a signal radiated by each of the foregoing three antennas may cover one cell. Specifically, a signal radiated by the first antenna may cover a first cell, a signal radiated by the second antenna may cover a second cell, and a signal radiated by the third antenna may cover a third cell. Specifically, the first cell, the second cell, and the third cell may each correspond to a sector area greater than 120°. Different cells may overlap, and collaborative operation of neighboring cells may be implemented by using a collaborative algorithm.

In an optional technical solution, when the foregoing three antennas are mounted on the mounting bracket, the three antennas may be evenly disposed around the mounting bracket, to implement uniformity of signals around the mounting bracket. Certainly, the three antennas may alternatively be unevenly disposed based on an actual use requirement. Details are not described herein.

### BRIEF DESCRIPTION OF THE DRAWINGS

FIG. 1 is a schematic of an architecture of a communication system to which an embodiment of this application is applicable;

FIG. 2 is a diagram of a structure of a communication system according to a possible embodiment of this application;

FIG. 3 is a diagram of composition of an antenna according to a possible embodiment of this application;

FIG. 4 is a diagram of a possible structure of an antenna according to an embodiment of this application;

FIG. 5A is a schematic top view of a structure of an antenna according to an embodiment of this application;

FIG. 5B is another schematic top view of a structure of an antenna according to an embodiment of this application;

FIG. 5C is another schematic top view of a structure of an antenna according to an embodiment of this application;

FIG. 6 is another schematic top view of a structure of an antenna according to an embodiment of this application;

FIG. 7 is another schematic top view of a structure of an antenna according to an embodiment of this application;

FIG. 8 is another diagram of a structure of an antenna according to an embodiment of this application;

FIG. 9A is another diagram of a structure of an antenna according to an embodiment of this application;

FIG. 9B is another diagram of a structure of an antenna according to an embodiment of this application;

FIG. 10A to FIG. 10F are several diagrams of possible structures of an antenna according to embodiments of this application;

FIG. 11A is a diagram of an orthographic projection of a side radiating element array on a front mounting plate according to an embodiment of this application;

FIG. 11B is another diagram of an orthographic projection of a side radiating element array on a front mounting plate according to an embodiment of this application;

FIG. 12 is a diagram of a structure of an antenna according to an embodiment of this application;

FIG. 13 is a diagram of a structure of a circuit module according to an embodiment of this application;

FIG. 14 is a diagram of a structure of a circuit module according to an embodiment of this application;

FIG. 15 is a diagram of a structure of a circuit module according to an embodiment of this application;

FIG. 16 shows an application scenario of an antenna according to an embodiment of

this application;

FIG. 17 shows another application scenario of an antenna according to an embodiment of this application;

FIG. 18 is a diagram of a structure of a first calibration module according to an embodiment of this application;

FIG. 19 is a diagram of a structure of an antenna according to an embodiment of this application;

FIG. 20 is a diagram of a structure of a communication system according to an embodiment of this application;

FIG. 21 is another diagram of a structure of a communication system according to an embodiment of this application;

FIG. 22 is a diagram of a networking structure of a communication system according to an embodiment of this application;

FIG. 23 is an antenna pattern of a communication system according to an embodiment of this application;

FIG. 24 is a diagram of a networking structure of a communication system according to an embodiment of this application;

FIG. 25 is a diagram of a networking structure of a communication system according to an embodiment of this application;

FIG. 26 is a diagram of a structure of a communication system according to an embodiment of this application;

FIG. 27 shows a networking form of a communication system according to an embodiment of this application;

FIG. 28 shows another networking form of a communication system according to an embodiment of this application;

FIG. 29 is another diagram of a structure of a communication system according to an embodiment of this application; and

FIG. 30 shows another networking form of a communication system according to an embodiment of this application.

Reference numerals:

| | |
|---|---|
| 1. Antenna; | 11. Front mounting surface; |
| 12. Side mounting surface; | 13. Radiating element array; |
| 131. Front radiating element array; | 132. Side radiating element array; |
| 14. Front mounting plate; | 141. First folding portion; |
| 15. Side mounting plate; | 151. Second folding portion; |
| 16. Circuit module; | 161. Antenna port; |
| 162. Radio frequency port; | 163. Bridge; |
| 164. Shifter; | 17. Coupler; |
| 18. Power splitter; | 19. Radome; |
| 110. Reflecting plate; | 111. Feed network; |
| 112. Calibration network; | 113. Phase shifter; |
| 114. Combiner; | 115. Filter; |
| 116. Mounting kit; | 1161. Connector; |
| 117. Radio frequency board; | 118. Heat sink; |
| 1′. First antenna; | 1″. Second antenna; |
| 1′″. Third antenna; | 2. Mounting bracket; |
| 3. Cell; | 3′. First cell; |
| 3″. Second cell; | 3′″. Third cell; |
| 4. Antenna adjustment bracket; | 5. Radio frequency processing unit; |
| 6. Baseband processing unit; and | 7. Cable. |

### DETAILED DESCRIPTION OF ILLUSTRATIVE EMBODIMENTS

To facilitate understanding of an antenna and a communication system provided in embodiments of this application, the following describes an application scenario of the antenna and the communication system. FIG. 1 is a schematic of an architecture of a communication system to which an embodiment of this application is applicable. As shown in FIG. 1, the communication system may be a base station antenna feeder system. The application scenario may include a base station and a terminal. Wireless communication may be implemented between the base station and the terminal. The base station may be located in a base station subsystem (BBS), a terrestrial radio access network (UTRAN), or an evolved terrestrial radio access network (E-UTRAN), and is used for cell coverage of a radio signal, to implement communication between the terminal device and a wireless network. Specifically, the base station may be a base transceiver station (BTS) in a global system for mobile communications (GSM) system or a code division multiple access (CDMA) system, may be a NodeB (NB) in a wideband code division multiple access (WCDMA) system, may be an evolved NodeB (eNB or eNodeB) in a long term evolution (LTE) system, or may be a radio controller in a cloud radio access network (CRAN) scenario. Alternatively, the base station may be a relay station, an access point, a vehicle-mounted device, a wearable device, a generational nodeB (gNodeB or gNB) in a new radio (NR) system, a base station in a future evolved network, or the like. This is not limited in embodiments of this application.

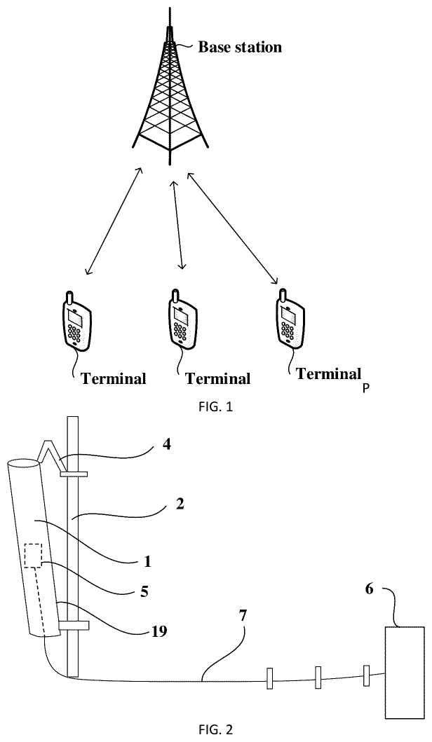

FIG. 2 is a diagram of a possible structure of a communication system. A base station antenna feeder system may usually include structures such as an antenna 1, a mounting bracket 2, and an antenna adjustment bracket 4. The antenna 1 of a base station includes a radome 19. The radome 19 has a good electromagnetic wave penetration characteristic in terms of electrical performance, and can withstand impact of an external harsh environment in terms of mechanical performance, so that the antenna 1 can be protected from the impact of the external environment. The antenna 1 may be mounted on the mounting bracket 2 through the antenna adjustment bracket 4, to facilitate receiving or transmitting of a signal of the antenna 1. Certainly, the embodiment shown in FIG. 2 is merely used as an optional implementation. In a specific implementation, an antenna and a base station antenna feeder system in embodiments of this application may be different from the antenna and the base station antenna feeder system in the embodiment shown in FIG. 2.

In addition, the base station may further include a radio frequency processing unit 5 and a baseband processing unit 6. For example, the radio frequency processing unit 5 may be configured to: perform frequency selection, amplification, and down-conversion processing on a signal received by the antenna 1, convert the signal into an intermediate frequency signal or a baseband signal, and send the intermediate frequency signal or the baseband signal to the baseband processing unit 6. Alternatively, the radio frequency processing unit 5 is configured to: perform up-conversion and amplification processing on the baseband processing unit 6 or an intermediate frequency signal, convert the baseband processing unit 6 or the intermediate frequency signal into an electromagnetic wave through the antenna 1, and send the electromagnetic wave through the antenna 1. The baseband processing unit 6 may be connected to a feed network of the antenna 1 through the radio frequency processing unit 5. In some implementations, the radio frequency processing unit 5 may also be referred to as a remote radio unit (RRU), or may be a radio frequency module in an active antenna unit (AAU). The baseband processing unit 6 may also be referred to as a baseband unit (BBU).

In a possible embodiment, as shown in FIG. 2, the radio frequency processing unit 5 and the antenna 1 may be integrally disposed, and the baseband processing unit 6 is located at a remote end of the antenna 1. In some other embodiments, both the radio frequency processing unit 5 and the baseband processing unit 6 may be located at a remote end of the antenna 1. The radio frequency processing unit 5 and the baseband processing unit 6 may be connected through a cable 7.

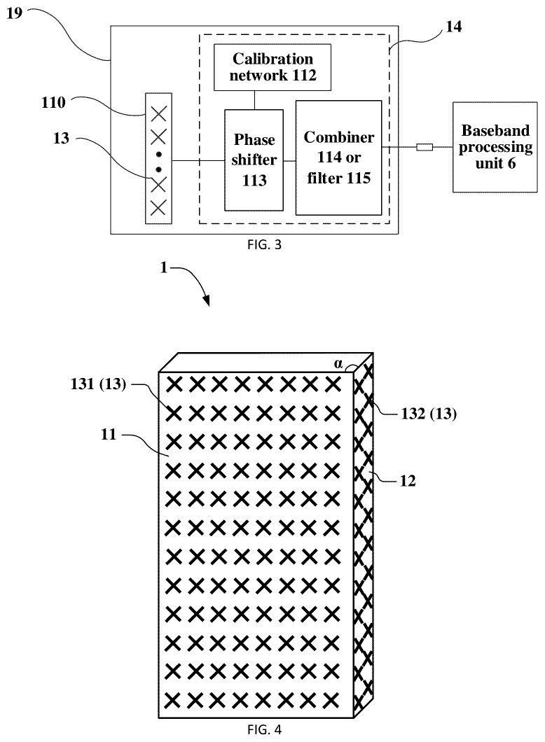

More specifically, refer to FIG. 2 and FIG. 3 together. FIG. 3 is a diagram of

composition of an antenna according to a possible embodiment of this application. As shown in FIG. 3, the antenna 1 of a base station may include radiating element arrays 13 and a reflecting plate 110. The radiating element array 13 may also be referred to as an antenna element, an element, or the like, and can effectively send or receive an antenna signal. In the antenna 1, frequencies of different radiating element arrays 13 may be the same or different. The reflecting plate 110 may also be referred to as a baseplate, an antenna panel, a reflection surface, or the like, and may be made of a metal material. When the antenna 1 receives a signal, the reflecting plate 110 may reflect the antenna signal to a target coverage area. When the antenna 1 transmits a signal, the reflecting plate 110 may reflect and transmit the signal that is transmitted to the reflecting plate 110. The radiating element array 13 is usually placed on a surface of one side of the reflecting plate 110. This not only can greatly enhance a signal receiving or transmitting capability of the antenna 1, but also can block and shield interference of other radio waves from the back of the reflecting plate 110 (where in this application, the back of the reflecting plate 110 refers to a side opposite to a side of the reflecting plate 110 on which the radiating element array 13 is disposed) to signal receiving of the antenna.

In the antenna 1 of the base station, the radiating element array 13 is connected to a feed network 111. The feed network 111 usually includes a controlled impedance transmission line. The feed network 111 may feed a signal to the radiating element array 13 based on a specific amplitude and phase, or send a received signal to the baseband processing unit 6 of the base station based on a specific amplitude and phase. Specifically, in some implementations, the feed network 111 may be used to implement beam radiation in different directions, or may be connected to a calibration network 112 to obtain a calibration signal required by a system. The feed network 111 may include a phase shifter 113, to change a phase of antenna signal radiation. Some modules for extending performance may be further disposed in the feed network 111. For example, a combiner 114 may be configured to: combine signals of different frequencies into one path of signals, and transmit the signal through the antenna 1; or when used in reverse, may be configured to: divide a signal received by the antenna 1 into a plurality of path of signals based on different frequencies, and transmit the signals to the baseband processing unit 6 for processing. For another example, a filter 115 is configured to filter out an interference signal.

It should be noted that embodiments that are related to terms such as “specific”, “specifically disposed”, and “specifically designed” in this application are all optional embodiments. In other words, this embodiment is a possible specific embodiment under the inventive concept of this application, but further includes another possible embodiment.

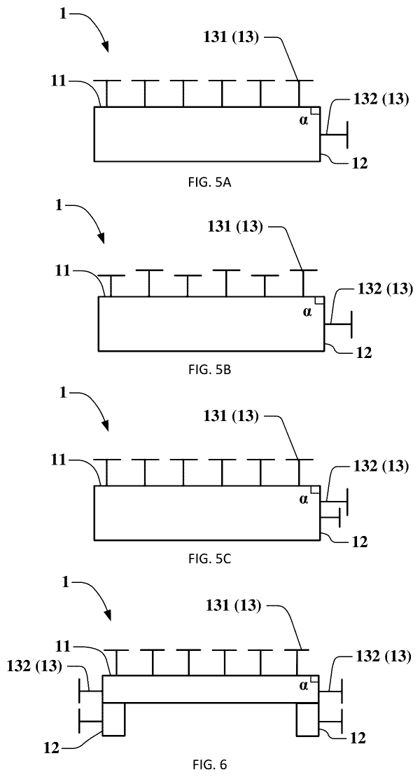

FIG. 4 is a diagram of a possible structure of an antenna according to an embodiment of this application. FIG. 5A is a schematic top view of a structure of an antenna according to an embodiment of this application. As shown in FIG. 4 and FIG. 5A, the antenna 1 includes a front mounting surface 11, a side mounting surface 12, and radiating element arrays 13. The radiating element arrays 13 include a front radiating element array 131 and a side radiating element array 132. The front radiating element array 131 is mounted on the front mounting surface 11. The side radiating element array 132 is mounted on the side mounting surface 12. It may be considered that a radiating surface of the front radiating element array 131 is parallel to the front mounting surface 11, and a radiating surface of the side radiating element array 132 is parallel to the side mounting surface 12. Certainly, in some embodiments, based on an actual requirement, the radiating surface of the front radiating element array 131 may not be parallel to the front mounting surface 11, and the radiating surface of the side radiating element array 132 may not be parallel to the side mounting surface 12. An included angle that is between the front mounting surface 11 and the side mounting surface 12 and that is on a side away from the front radiating element array 131 is a first included angle, and the first included angle is less than 180°. Specifically, it may be considered that the first included angle is an included angle that is in included angles between the front mounting surface 11 and the side mounting surface 12 and that is away from the front radiating element array 131 and the side radiating element array 132. In other words, in this solution, in addition to the front radiating element array 131 disposed on a front surface of the antenna 1, the side radiating element array 132 may be disposed on a side surface of the antenna 1. In this solution, an area of an antenna surface of the antenna 1 may be expanded without increasing an area occupied by the front mounting surface 11 of the antenna. The antenna surface may be referred to as an antenna port surface, an antenna panel, or the like, and may specifically refer to an area covered by a radiating element of the antenna 1. Therefore, coverage of the antenna 1 can be improved and performance of the antenna 1 can be improved without increasing wind load and mounting space.

Specifically, the front mounting surface 11 refers to a surface used to mount the radiating element, and may be specifically a mounting surface that is in a direction away from the mounting bracket 2 and that is of the antenna 1 in a use state. The side mounting surface 12 also refers to a surface used to mount the radiating element, and may be specifically a mounting surface on a side adjacent to the front mounting surface 11. The antenna 1 usually includes a plurality of radiating elements. During actual operation, the plurality of radiating elements are divided into radiating element arrays 13. Specifically, some of the plurality of radiating elements may form one radiating element array 13. During actual operation, a signal radiated by the antenna 1 may be controlled by using the radiating element array 13 as a unit. A division manner of the radiating element array 13 is not limited. For example, a plurality of radiating elements on one mounting surface may be arranged in a matrix, so that one column of radiating elements may form one radiating element array 13, or two adjacent columns of radiating elements may form one radiating element array 13, or radiating elements corresponding to a small matrix of several rows and several columns may form one radiating element array 13. This is not limited in this application.

It should be noted that, in addition to the front radiating element array 131 and the side radiating element array 132, the antenna 1 in this embodiment of this application may further include another radiating element array 13. This is not limited in this application. For example, the antenna 1 may further include another mounting surface, to mount the radiating element array 13.

Mounting and layout manners of the radiating element array of the antenna in the accompanying drawings in embodiments of this application are merely examples, and are not limited in embodiments of this application.

In addition, in an optional embodiment, the front radiating element array may include at least two radiating element arrays. Operating frequencies of the at least two radiating element arrays may be the same or may be different. This is not limited in this application. In addition, sizes of radiating elements in the at least two radiating element arrays are not limited, and may be the same or different. Similarly, the side radiating element array may also include at least two radiating element arrays. Operating frequencies of the at least two radiating element arrays may be the same or may be different. This is not limited in this application. In addition, sizes of radiating elements in the at least two radiating element arrays are not limited, and may be the same or different. For example, in an embodiment shown in FIG. 5B, the front radiating element array includes radiating elements of different sizes; and in an embodiment shown in FIG. 5C, the side radiating element array includes radiating elements of different sizes. Various cases are not listed one by one herein.

FIG. 6 is another schematic top view of a structure of an antenna according to an embodiment of this application. As shown in FIG. 6, in a specific embodiment, the angle α of the first included angle may be 90°. In other words, the front mounting surface 11 is disposed perpendicular to the side mounting surface 12. In this solution, there is small impact on wind load of the antenna 1, and an angle of a radiation range of the antenna 1 may be larger.

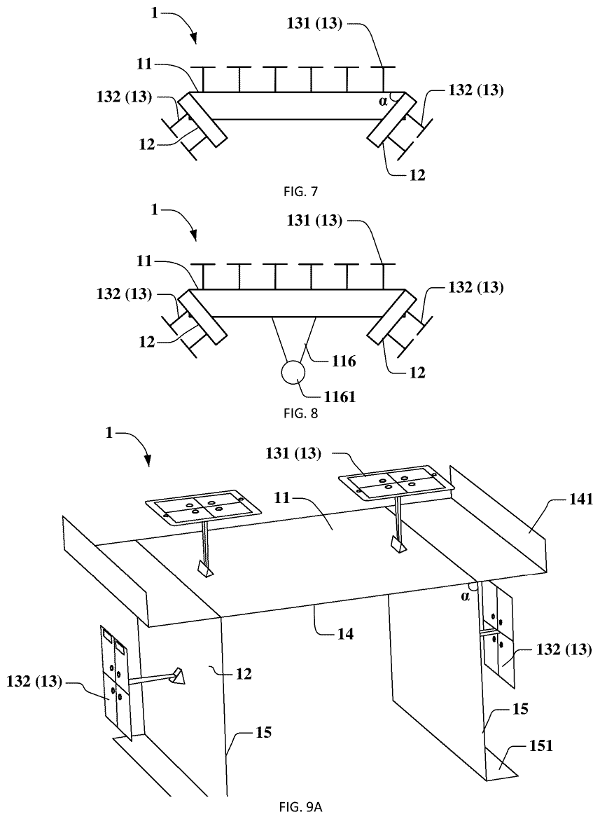

FIG. 7 is another schematic top view of a structure of an antenna according to an embodiment of this application. As shown in FIG. 7, in another embodiment, the angle α of the included angle may alternatively be less than 90°. In other words, the side mounting surface 12 tilts towards a back side of the front mounting surface 11. In this solution, wind load and mounting space are small. In addition, an angle of a radiation range of the antenna 1 can be further increased, and radiation intensity on a side away from the front mounting surface 11 is also high.

In an optional embodiment, the angle α of the first included angle ranges from 60° to 120°. Specifically, the first included angle α may be designed based on an actual radiation range requirement of the antenna 1. This is not limited in this application.

FIG. 8 is another diagram of a structure of an antenna according to an embodiment of this application. As shown in FIG. 8, in an embodiment, the antenna 1 further includes a mounting kit 116. The front mounting surface 11 and the side mounting surface 12 are mounted on a pole through the mounting kit 116. The mounting kit 116 includes a connector 1161. Specifically, the front mounting surface 11 and the side mounting surface 12 are mounted on and connected to the pole through the connector 1161. When the mounting kit 116 is specifically disposed, the connector 1161 is located on a side that is of the front mounting surface 11 and that is away from the front radiating element array 131, and an orthographic projection of the connector 1161 on the front mounting surface 11 is on an axis of symmetry of the front mounting surface 11. In this solution, the structure of the antenna 1 can be symmetrical relative to the pole. This helps improve mounting stability of the antenna 1. In addition, in this solution, the front mounting surface 11 and the side mounting surface 12 may be first fixed into an integrated structure, and then a plurality of mounting surfaces of the antenna 1 may be mounted by using one mounting kit 116. This helps reduce a quantity of accessories of the antenna 1 and reduce a weight of the entire antenna 1.

Still refer to FIG. 8. In a further embodiment, a distance between the connector 1161 and the front mounting surface 11 is greater than a distance between any position of the side mounting surface and the front mounting surface 11. In other words, the connector 1161 is located on outer sides of all front mounting surfaces 11 and side mounting surfaces 12, so that a plurality of antennas 1 may be mounted on a same pole, to reduce space occupied by the antennas 1. In addition, the front mounting surface 11 and the side mounting surface 12 of the antenna 1 may be disposed in one radome, and radiating element arrays in the radome are mounted on the pole as a whole.

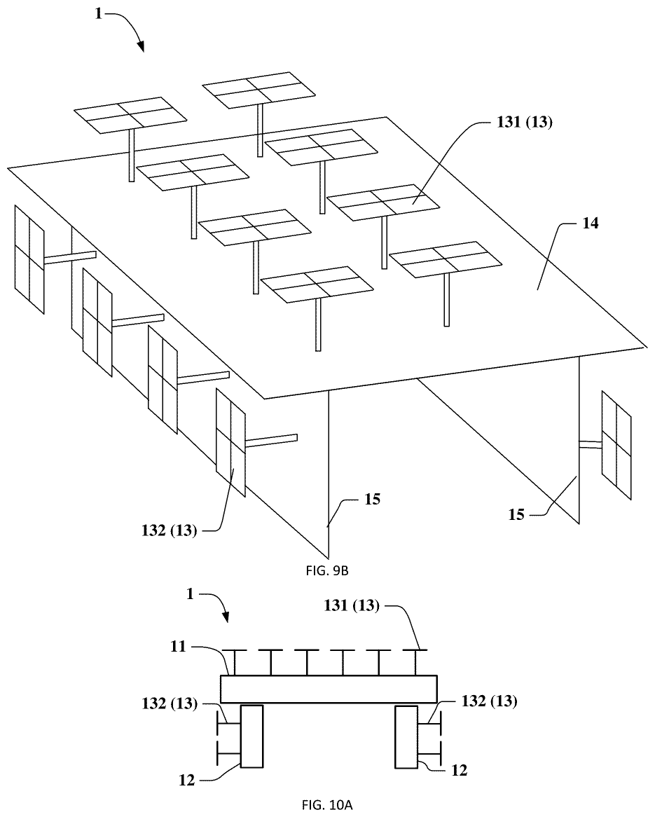

FIG. 9A is another diagram of a structure of an antenna according to an embodiment of this application. FIG. 9B is another diagram of a structure of an antenna according to an embodiment of this application. As shown in FIG. 9A and FIG. 9B, the antenna 1 further includes a front mounting plate 14 and a side mounting plate 15. The front mounting surface 11 is located on the front mounting plate 14, and the side mounting surface 12 is located on the side mounting plate 15. The front mounting plate 14 may be connected to the side mounting plate 15 through welding, a threaded connection, integrated molding, or the like.

When the front mounting plate 14 and the side mounting plate 15 are specifically disposed, an included angle between the front mounting plate and the side mounting plate 15 is not limited. For example, the side mounting plate 15 may be disposed perpendicular to the front mounting plate 14. Alternatively, a surface of a side that is of the side mounting plate 15 and that is away from the side radiating element array 132 may be a first surface, a surface that is of the front mounting plate 14 and that is adjacent to the side mounting plate 15 is a second surface, and an included angle between the first surface and the second surface may be an acute angle. This is not limited in this application.

In a possible implementation, the front mounting plate 14 may include a reflecting plate, and the side mounting plate 15 may also include a reflecting plate. Specifically, the front mounting plate 14 and the side mounting plate 15 may be made of a metal material. When the antenna 1 receives a signal, the reflecting plate may reflect the antenna signal to a target coverage area. When the antenna transmits a signal, the reflecting plate may reflect and transmit the signal that is transmitted to the reflecting plate.

Still refer to FIG. 9A. In a possible implementation, an edge of the front mounting plate 14 may have a first folding portion 141, and the first folding portion 141 is located on a side of the front mounting plate 14 on which the front radiating element array 131 is mounted. In other words, the front mounting plate 14 has the first folding portion 141 that folds in a direction towards the front radiating element. In this solution, strength of a signal radiated from the back of the front mounting plate 14 by the antenna 1 can be reduced, and a front-to-back ratio of the antenna 1 can be increased.

Alternatively, an edge of the side mounting plate 15 may have a second folding portion 151, and the second folding portion 151 is located on a side of the side mounting plate 15 on which the side radiating element array 132 is mounted. In other words, the side mounting plate 15 has the second folding portion 151 that folds in a direction towards the side radiating element. Similarly, in this solution, strength of a signal radiated from the back of the side mounting plate 15 by the antenna 1 can be reduced, and a front-to-back ratio of the antenna 1 can be increased.

In a specific implementation, only the front mounting plate 14 may have the first folding portion 141, or only the side mounting plate 15 may have the second folding portion 151, or the front mounting plate 14 may have the first folding portion 141, and the side mounting plate 15 may have the second folding portion 151. This may be designed based on an actual requirement.

Refer to FIG. 4 and FIG. 5A. When the antenna 1 is specifically designed, based on a requirement, the side mounting surface 12 may be disposed only on one side of the front mounting surface 11, and the side radiating element array 132 is disposed on the side mounting surface 12. For example, when there is a requirement or a high requirement for a signal radiated by the antenna 1 only on one side of the front mounting surface 11 of the antenna 1, the side radiating element array 132 is disposed only on this side.

Refer to FIG. 6 to FIG. 9A. In another embodiment, side mounting surfaces 12 may be further disposed on two opposite sides of the front mounting surface 11, and the side radiating element array 132 is mounted on each side mounting surface 12. Specifically, the antenna 1 may include one front mounting surface 11 and two side mounting surfaces 12. The two side mounting surfaces 12 are respectively disposed on two opposite side surfaces of the front mounting surface 11. The front radiating element array 131 is disposed on the front mounting surface 11, and the side radiating element array 132 is disposed on the side mounting surface 12. In other words, side radiating element arrays 132 are disposed on two sides of the front radiating element array 131. In this solution, the performance of the antenna 1 can be improved to a great extent while it is ensured that space occupied by the front mounting surface 11 of the antenna 1 is fixed.

Certainly, in a specific embodiment, the side radiating element arrays 132 on the two sides of the front radiating element array 131 on the front mounting surface 11 may be symmetrically disposed, or may be asymmetrically disposed. This is specifically designed based on a requirement.

When each mounting plate of the antenna 1 is specifically disposed, a specific position of the mounting plate may not be limited. In a specific embodiment, for example, the antenna 1 includes one front mounting plate and two side mounting plates, and the two side mounting plates may be symmetrically disposed on two sides of the front mounting plate. The following lists several possible arrangement manners.

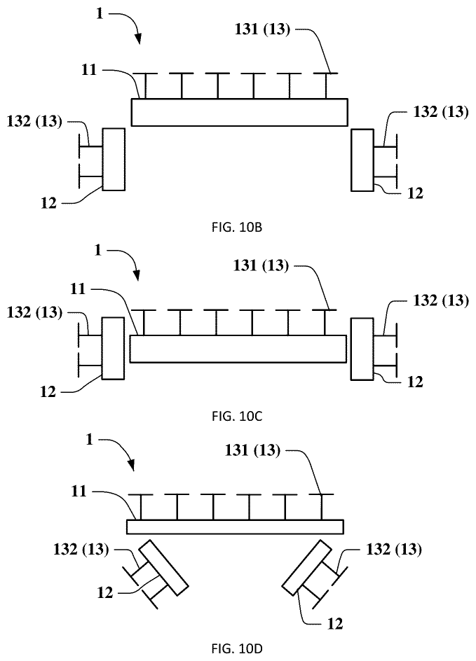

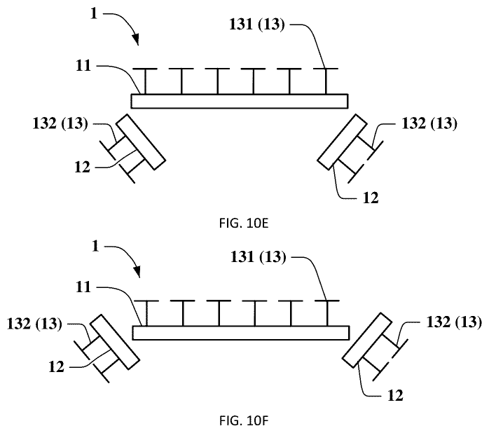

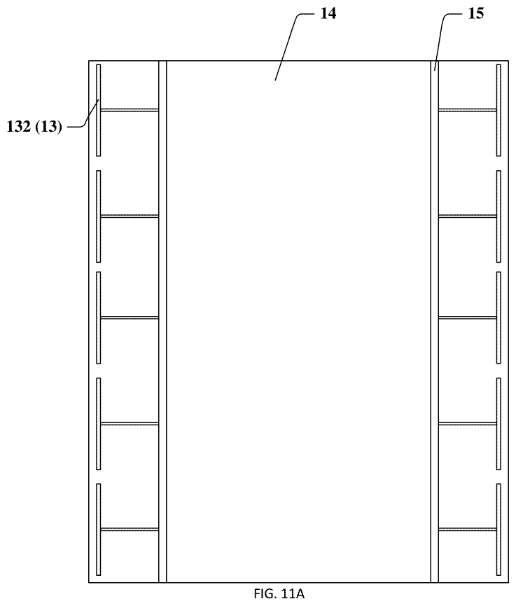

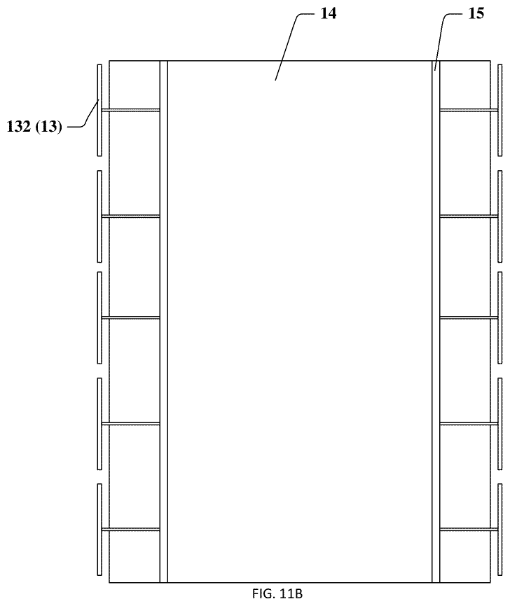

FIG. 10A to FIG. 10F are several diagrams of possible structures of an antenna according to embodiments of this application. As shown in FIG. 10A to FIG. 10C, a side mounting plate is perpendicular to a front mounting plate. In this case, as shown in FIG. 10A, in an embodiment, the side mounting plate is located on a side that is of the front mounting plate and that is away from a front radiating element array 131. Specifically, an orthographic projection of the side mounting plate on a plane on which the front mounting plate is located may be completely on the front mounting plate. In other words, the front mounting plate may completely block the side mounting plate. As shown in FIG. 10B, in another embodiment, the side mounting plate is located on an outer side of the front mounting plate. Specifically, an orthographic projection of the side mounting plate on a plane on which the front mounting plate is located may be completely on the outer side of the front mounting plate. As shown in FIG. 10C, in another embodiment, the front mounting plate is located between side mounting plates. As shown in FIG. 10D to FIG. 10F, in other embodiments, a side mounting plate and a front mounting kit 116 may be disposed at an acute angle. As shown in FIG. 10D, in an embodiment, the side mounting plate is located on a side that is of the front mounting plate and that is away from a front radiating element array 131. Specifically, an orthographic projection of the side mounting plate on a plane on which the front mounting plate is located may be completely on the front mounting plate. In other words, the front mounting plate may completely block the side mounting plate. As shown in FIG. 10E, in another embodiment, the side mounting plate and the front mounting plate are connected on an outer side of the front mounting plate. As shown in FIG. 10F, in another embodiment, the front mounting plate is located between side mounting plates.

Still refer to FIG. 10A to FIG. 10F. When the antenna 1 includes one front mounting surface 11 and two side mounting surfaces 12, the two side mounting surfaces 12 include a first side mounting surface and a second side mounting surface. m columns of front radiating element arrays 131 are disposed on the front mounting surface 11. n columns of side radiating element arrays 132 are disposed on the first side radiating surface. s columns of side radiating element arrays 132 are disposed on the second side radiating surface. m, n, and s satisfy that m:n:s=a:b:a, where both a and b are integers greater than 0, and b>a. In this solution, a quantity of side radiating element arrays 132 is less than a quantity of front radiating element arrays 131, and sizes of the side mounting surfaces 12 on two sides are small. This helps reduce a thickness of the antenna 1 and reduce a section of the antenna 1.

In a specific embodiment, it may be assumed that b=2 and a=1. This solution facilitates power sharing by using a bridge, to cover a 3 dB/4.7 dB signal. In addition, it may be assumed that b=4 and a=1, b=4 and a=2, b=8 and a=1, b=8 and a=2, b=8 and a=4, b=8 and a=6, b=10 and a=4, or the like. This is not specifically limited in this application.

FIG. 11A is a diagram of an orthographic projection of a side radiating element array on a front mounting plate according to an embodiment of this application. As shown in FIG. 11A, the orthographic projection of the side radiating element array 132 on the front mounting plate 14 is completely on the front mounting plate 14. In this solution, the front mounting plate 14 may be used to separate a front radiating element array 131 and the side radiating element array 132, to reduce crosstalk between the front radiating element array 131 and the side radiating element array 132.

FIG. 11B is another diagram of an orthographic projection of a side radiating element array on a front mounting plate according to an embodiment of this application. As shown in FIG. 11B, in another embodiment, the orthographic projection of the side radiating element array 132 on the front mounting plate 14 may be partially on the front mounting plate 14. This helps reduce an area occupied by the front mounting plate 14, and helps increase a radiation range of a side radiating element.

In addition, the orthographic projection of the side radiating element array 132 on a plane on which the front mounting plate 14 is located may not be on the front mounting plate 14 at all. The antenna in this embodiment is suitable for use at permitted wind load.

The antenna 1 may be specifically an active antenna, or may be a passive antenna. Both types of antennas 1 are applicable to the foregoing antenna architecture. This is not limited in this application. Specifically, the active antenna may refer to an antenna on which an active device is disposed, or the active antenna may refer to an antenna including a radio frequency channel module.

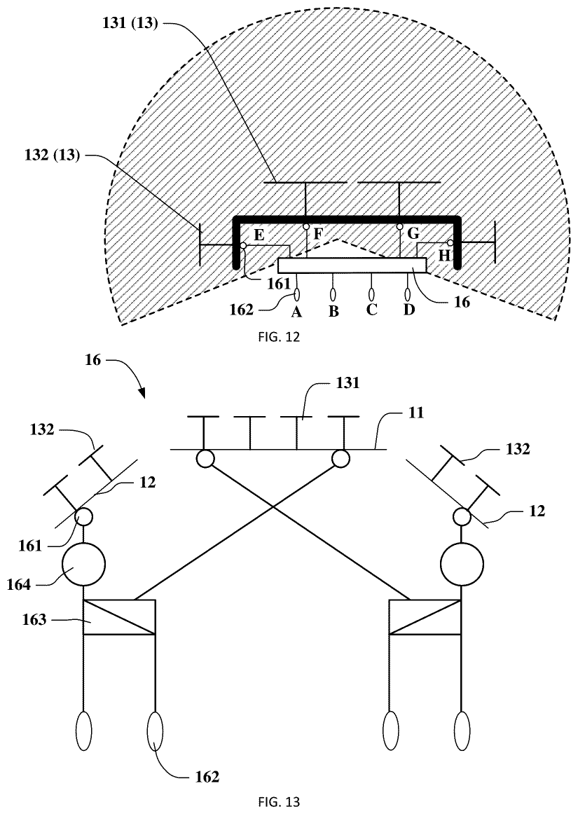

FIG. 12 is a diagram of a structure of an antenna according to an embodiment of this application. As shown in FIG. 12, in a specific embodiment, the antenna 1 further includes a circuit module 16. A front radiating element array 131 is connected to an antenna port 161, and a side radiating element array 132 is also connected to an antenna port 161. One end of the circuit module 16 is connected to the antenna port 161 connected to the front radiating element array 131 and the antenna port 161 connected to the side radiating element array 132, and another end of the circuit module 16 is configured to connect to a plurality of radio frequency ports 162. When the antenna 1 is a passive antenna unit, the radio frequency port 162 may be a port of a remote radio unit (Remote radio unit, RRU); or when the antenna 1 is an active antenna (Active antenna unit, AAU), the radio frequency port 162 is a radio frequency port of a radio frequency channel module of the active antenna. It is easy to understand that the circuit module 16 includes a feed network or a feed module. In this solution, the front radiating element array and the side radiating element array of the antenna may be connected to one remote radio unit through the circuit module, so that both the front radiating element array 131 and the side radiating element array 132 can be driven, and a cell covered by the front radiating element array 131 and a cell covered by the side radiating element array 132 may be a same cell or different cells. This is not limited in this application.

It should be noted that, in an optional embodiment, the antenna may include at least two front radiating element arrays 131 and at least two side radiating element arrays 132. In this case, the circuit module 16 may be connected to antenna ports 161 connected to some of the front radiating element arrays 131 and antenna ports 161 connected to some of the side radiating element arrays 132. In other words, not all radiating element arrays 13 have an antenna port 161 connected to the circuit module 16, but the circuit module 16 is connected to at least an antenna port 161 connected to one front radiating element array and an antenna port connected to one side radiating element array. In another optional embodiment, the circuit module 16 may be connected to antenna ports 161 connected to all the front radiating element arrays 131 and antenna ports 161 connected to all the side radiating element arrays 132.

The antenna port 161 is specifically connected to a radiating element of the antenna 1. In an optional implementation, the antenna port 161 may be connected to one radiating element or connected to at least two radiating elements. This is not limited in this application. In an optional embodiment, the radiating element array 13 may be in one-to-one correspondence with the antenna port 161. Certainly, it may be understood that in another embodiment, the radiating element array 13 may not be disposed in one-to-one correspondence with the antenna port 161. For example, in a possible embodiment, each radiating element array 13 in the front radiating element array 131 and the side radiating element array 132 is connected to one of the antenna ports 161. At least one antenna port 161 is electrically connected to at least two of the plurality of radio frequency ports 162 through the circuit module 16. In a conventional implementation, the antenna ports 161 are directly connected to the radio frequency ports 162 in one-to-one correspondence. In this case, power provided by each radio frequency port 162 can be transmitted only to an antenna port 161 connected to the radio frequency port 162, that is, can only be used to drive one array, and power of each array cannot be adjusted in real time based on a requirement. The circuit module 16 in this embodiment may specifically implement reallocation of input power of the antenna 1, to implement power sharing between subarrays of the antenna 1. Therefore, in this solution, input power of the antenna port 161 can be allocated based on an actual requirement, and coverage of a signal radiated by the antenna 1 and a channel capacity can be adjusted.

In a specific embodiment, any one of a plurality of antenna ports 161 may be connected to any one of the plurality of radio frequency ports 162 through the circuit module 16. In this solution, input power of all the antenna ports 161 can be allocated based on an actual requirement.

The circuit module 16 may be an analog circuit module, and a specific form of the analog circuit module is not limited. FIG. 13 shows a form of the circuit module. In an embodiment shown in FIG. 13, an analog circuit includes a bridge 163 and a shifter 164, so that each antenna port 161 connected to the circuit module 16 may be electrically connected to any one of the radio frequency ports 162. In this way, power input by each radio frequency port 162 can be transmitted to any antenna port 161, to implement power reallocation. Therefore, coverage of a signal radiated by the antenna 1 can be adjusted based on a requirement, and a channel capacity in a specified range can be increased. FIG. 13 shows only a possible implementation of the circuit module 16. For example, in another embodiment, the circuit module 16 may further include at least one of electrical devices such as a bridge 163, a shifter 164, and a power splitter.

In a specific embodiment, the bridge 163 includes an input port and an output port. The input port of the bridge 163 is connected to the radio frequency port 162. The output port of the bridge 163 is separately connected to the front radiating element array 131 and the side radiating element array 132.

A specific composition form of the bridge 163 is not limited. As shown in FIG. 13, in an embodiment, the circuit module 16 may include two bridges 163. The two bridges 163 are respectively a first bridge and a second bridge. The first electric bridge includes a first input port, a second input port, a first output port, and a second output port. The first output port is connected to a column of front radiating element arrays 131 disposed on a front mounting surface 11, and is specifically connected to an antenna port 161 connected to the column of front radiating element arrays 131. The second output port is connected to a column of side radiating element arrays 132 on a first side radiating surface, and is specifically connected to an antenna port 161 connected to the column of side radiating element arrays 132. The first input port and the second input port each are connected to the radio frequency port 162. Similarly, the second bridge includes a third input port, a fourth input port, a third output port, and a fourth output port. The third output port is connected to another column of front radiating element arrays 131 disposed on the front mounting surface 11, and is specifically connected to an antenna port 161 connected to the another column of front radiating element arrays 131. The fourth output port is connected to a side radiating element array 132 on a second side radiating surface, and is specifically connected to an antenna port 161 connected to the side radiating element array 132. The third input port and the fourth input port each are connected to the radio frequency port 162.

The first bridge and the second bridge are specifically a 2*2 Butler matrix, and are also referred to as 3 dB 90° bridges. The matrix is specifically:

$$[ \begin{matrix}1 & j \\ j & 1\end{matrix} ] .$$

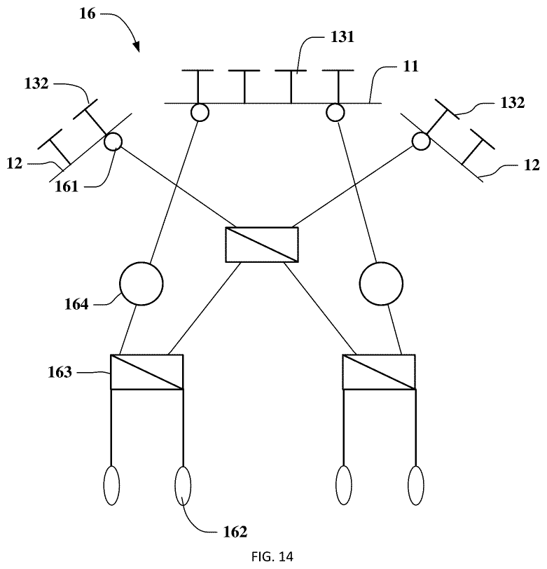

FIG. 14 shows a form of a circuit module. In an embodiment shown in FIG. 14, in another embodiment, the circuit module 16 may include three bridges 163. The three bridges 163 are a third bridge, a fourth bridge, and a fifth bridge. The third bridge includes a fifth input port, a sixth input port, a fifth output port, and a sixth output port. The fourth bridge includes a seventh input port, an eighth input port, a seventh output port, and an eighth output port. The fourth bridge includes a ninth input port, a tenth input port, a ninth output port, and a tenth output port. The fifth output port is connected to a column of side radiating element arrays 132 on a first side radiating surface, and is specifically connected to an antenna port 161 connected to the column of side radiating element arrays 132 on the first side radiating surface. The sixth output port is connected to a column of side radiating element arrays 132 on a second side radiating surface, and is specifically connected to an antenna port 161 connected to the column of side radiating element arrays 132 on the second side radiating surface. The fifth input port is connected to the seventh output port, and the sixth input port is connected to the ninth output port. The eighth output port is connected to a column of front radiating element arrays 131 disposed on a front mounting surface 11, and is specifically connected to an antenna port 161 connected to the column of front radiating element arrays 131 disposed on the front mounting surface 11. The tenth output port is connected to another column of front radiating element arrays 131 disposed on the front mounting surface 11, and is specifically connected to an antenna port 161 connected to the another column of front radiating element arrays 131 disposed on the front mounting surface 11. The seventh input port, the eighth input port, the ninth input port, and the tenth input port each are connected to a radio frequency port 162.

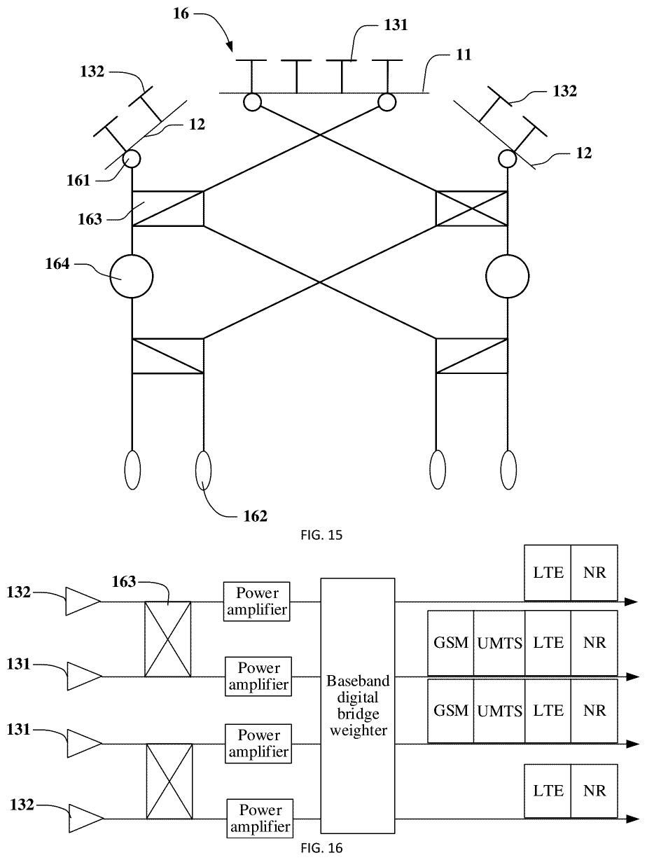

FIG. 15 shows a form of a circuit module. In an embodiment shown in FIG. 15, in another embodiment, the circuit module 16 may include four bridges 163. The four bridges 163 are a sixth bridge, a seventh bridge, an eighth bridge, and a ninth bridge. The sixth bridge includes an eleventh input port, a twelfth input port, an eleventh output port, and a twelfth output port. The seventh bridge includes a thirteenth input port, a fourteenth input port, a thirteenth output port, and a fourteenth output port. The eighth bridge includes a fifteenth input port, a sixteenth input port, a fifteenth output port, and a sixteenth output port. The ninth bridge includes a seventeenth input port, an eighteenth input port, a seventeenth output port, and an eighteenth output port. The eleventh output port is connected to a column of front radiating element arrays 131 disposed on a front mounting surface 11, and is specifically connected to an antenna port 161 connected to the column of front radiating element arrays 131 disposed on the front mounting surface 11. The twelfth output port is connected to a column of side radiating element arrays 132 on a first side radiating surface, and is specifically connected to an antenna port 161 connected to the column of side radiating element arrays 132 on the first side radiating surface. The eleventh input port is connected to the seventeenth output port. The twelfth input port is connected to the fifteenth output port. The thirteenth output port is connected to another column of front radiating element arrays 131 disposed on the front mounting surface 11, and is specifically connected to an antenna port 161 connected to the another column of front radiating element arrays 131 disposed on the front mounting surface 11. The fourteenth output port is connected to a side radiating element array 132 on a second side radiating surface, and is specifically connected to an antenna port 161 connected to the side radiating element array 132 on the second side radiating surface. The thirteenth input port is connected to the sixteenth output port. The fourteenth input port is connected to the eighteenth output port. The fifteenth input port, the sixteenth input port, the seventeenth input port, and the eighteenth input port are connected.

FIG. 16 shows an application scenario of an antenna according to an embodiment of this application. As shown in FIG. 16, each input port of a bridge is connected to one power amplifier, and each power amplifier is connected to a baseband digital bridge weighter. The baseband digital bridge weighter is an inverse matrix for bridge weighting. As shown in FIG. 16, some carriers are input simultaneously through four ports, to implement simultaneous radiation of all radiating element arrays of the antenna 1. For example, new radio (NR) and 3GPP long term evolution (LTE) are supported. In addition, some carriers are input through some ports (for example, an antenna port 161 corresponding to a front radiating element array 131). For example, a global system for mobile communications (GSM) and a universal mobile telecommunications service (UMTS) are supported. This implements radiation of only some radiating element arrays, for example, the front radiating element array 131. Alternatively, as shown in FIG. 17, some carriers are input simultaneously through four ports, to implement simultaneous radiation of all radiating element arrays of an antenna 1. For example, new radio (NR) is supported. In addition, some carriers are input through some ports (for example, an antenna port 161 corresponding to a front radiating element array 131). For example, 3GPP long term evolution (LTE), a global system for mobile communications (GSM), and a universal mobile telecommunications service (UMTS) are supported. This implements radiation of only some radiating element arrays, for example, the front radiating element array 131. In this manner, the antenna 1 may support simultaneous operation of four standards without causing a power waste.

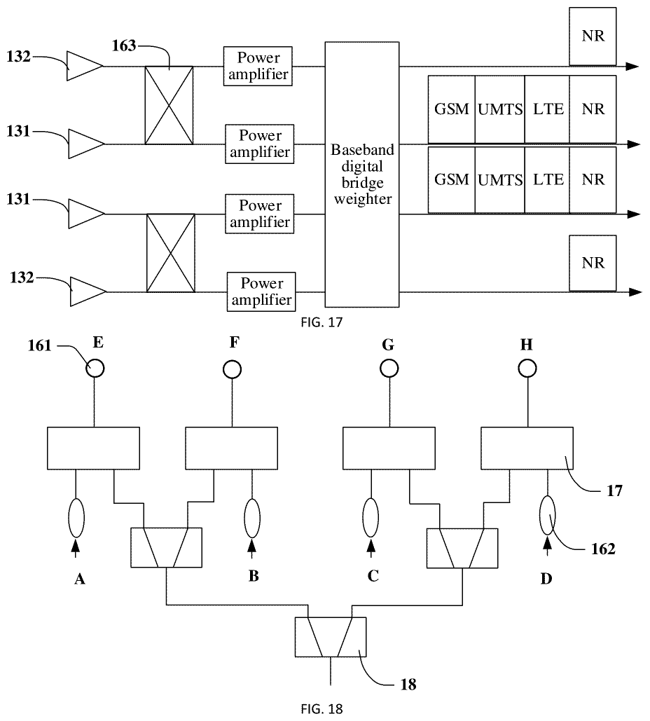

FIG. 18 is a diagram of a structure of a first calibration module according to an embodiment of this application. Refer to FIG. 18. In an embodiment, an antenna 1 may further include a first calibration module. The first calibration module may be specifically a calibration circuit module. Phases and amplitudes between different antenna ports 161 may be calibrated by using the calibration circuit module. This facilitates collaboration between the antenna ports 161, to obtain a required beamforming pattern, so as to improve performance of the antenna 1.

The first calibration module is disposed between a radio frequency port and an antenna port, but a specific position of the first calibration module is not limited. For example, the first calibration module may be specifically disposed between the radio frequency port and the circuit module; or the first calibration module may be specifically disposed between the circuit module and the antenna port; or the first calibration module and the circuit module may be integrated into an integrated structure. This is not limited in this application.

In a specific embodiment, a structure of the calibration circuit module is not limited. FIG. 18 shows a possible structure of the calibration circuit module. The calibration circuit includes a coupler 17 and a power splitter 18.

As shown in FIG. 18, in a specific embodiment, an antenna port 161 connected to each front radiating element array 131 is connected to one of a plurality of couplers, and an antenna port 161 connected to each side radiating element array 132 is connected to one of the plurality of couplers. Specifically, in the embodiment shown in FIG. 18, the antenna 1 includes two front radiating element arrays 131 and one side radiating element array 132 disposed on each of two sides. Antenna ports F and G in the figure are antenna ports 161 connected to the two front radiating element arrays 131. Antenna ports E and H in the figure are antenna ports 161 connected to the two side radiating element arrays 132. Each antenna port 161 is connected to one coupler. All couplers connected to each antenna 1 may be connected to one power splitter, so that signals of all radiating element arrays are converged.

Still refer to FIG. 18. In a further embodiment, one end of the power splitter away from the coupler is connected to a calibration circuit to perform calibration. Specifically, when the antenna 1 is an active antenna, the power splitter is connected to a calibration circuit of an active antenna unit of the active antenna; or when the antenna 1 is a passive antenna, the power splitter is connected to a calibration port of a remote radio unit of the passive antenna.

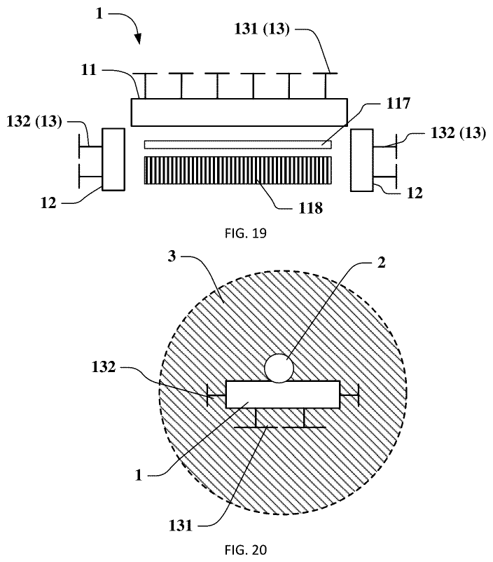

FIG. 19 is a diagram of a structure of an antenna according to an embodiment of this application. As shown in FIG. 19, in a specific embodiment, when the antenna 1 is an active antenna, the antenna 1 includes a radio frequency board 117 and a heat sink 118. The radio frequency board 117 may also be referred to as an active board, and is connected to a radiating element. In a downlink circuit, the radio frequency board 117 is configured to perform up-conversion on a digital intermediate frequency signal from a baseband processing unit into a radio frequency signal. In an uplink circuit, the radio frequency board 117 is configured to perform down conversion on a radio frequency signal into a digital intermediate frequency signal. The heat sink 118 is disposed on a side that is of the radio frequency board 117 and that is away from a front mounting surface 11. Both a front radiating element array 131 and a side radiating element array 132 are connected to the radio frequency board 117. In this solution, one radio frequency board 117 is connected to all radiating element arrays. This helps simplify the structure of the antenna 1, and facilitates calibration and collaboration between different radiating element arrays.

When the antenna 1 is a passive antenna, the passive antenna includes a remote radio unit, and the front radiating element array 131 and the side radiating element array 132 of the antenna 1 are both connected to the remote radio unit. In other words, all radiating element arrays of the antenna 1 are connected to one remote radio unit, to facilitate calibration and collaboration between different radiating element arrays.

The radiating element array 13 of the antenna 1 includes a plurality of radiating elements. Each radiating element is connected to an active component. The active component is configured to reconstruct a pattern of the radiating element. In this solution, based on an actual requirement, the pattern of the corresponding radiating element can be adjusted by using the active component, to change a direction of maximum radiation of the antenna. The antenna 1 may include a plurality of radiating element arrays 13. Each radiating element array 13 may include a plurality of radiating elements. A pattern of the radiating element is adjusted by using an active component, so that a pattern of the radiating element array 13 can be adjusted, to increase a degree of freedom in adjusting a pattern of the entire antenna 1, and implement 360° coverage of a signal radiated by a single antenna 1.

In a specific technical solution, the active component may include at least one of a diode, a capacitance tube, a varactor, a radio frequency microelectromechanical system (Microelectromechanical System, MEMS) switch, a liquid crystal, graphene, and a micro-mechanical rotating apparatus. This is not specifically limited in this application.

FIG. 20 is a diagram of a structure of a communication system according to an embodiment of this application. As shown in FIG. 20, this application further provides the communication system. The communication system includes a mounting bracket 2 and at least one antenna 1 in any one of the foregoing embodiments. The antenna 1 is mounted on the mounting bracket 2. In this embodiment, a radiation range of the antenna 1 is wide. This helps improve coverage and signal strength of the communication system. Specifically, at fixed signal strength, a quantity of antennas 1 disposed may be reduced, to reduce costs. When a quantity of antennas 1 mounted in the communication system is fixed, the signal strength of the communication system may be high.

It should be noted that the mounting bracket 2 is a structure used to mount the antenna 1. The mounting bracket 2 may be specifically a pole-shaped structure, a tower-shaped structure, or the like. In other words, the mounting bracket 2 in this embodiment of this application may be specifically a structure such as a pole, a tower, or the like used to mount the antenna. In addition, the mounting bracket 2 may include one pole or at least two poles. This is not limited in this application.

The communication system in this embodiment of this application may support various standards, for example, a global system for mobile communications (Global System for Mobile Communications, GSM), long term evolution (Long Term Evolution, LTE), or 5G new radio (New radio). The communication system may be used in a macro base station, a micro base station, an indoor site, or the like. This is not limited in this application.

Still refer to FIG. 20. Only one antenna 1 may be disposed in the communication system. A front radiating element array 131 is disposed on a front surface of the antenna 1, and a side radiating element array 132 is disposed on a side surface of the antenna 1. Particularly, when side radiating element arrays 132 are disposed on two sides of the front radiating element array 131 of the antenna 1, the antenna 1 can implement 360° coverage of a radiated signal, and the communication system can implement full coverage by using one antenna 1. This helps reduce costs of the communication system.

According to the embodiment shown in FIG. 20, a networking form of a single station with a single antenna and one cell can be implemented. When the communication system has only one antenna 1, 360° full coverage of a signal radiated from a cell 3 may be implemented.

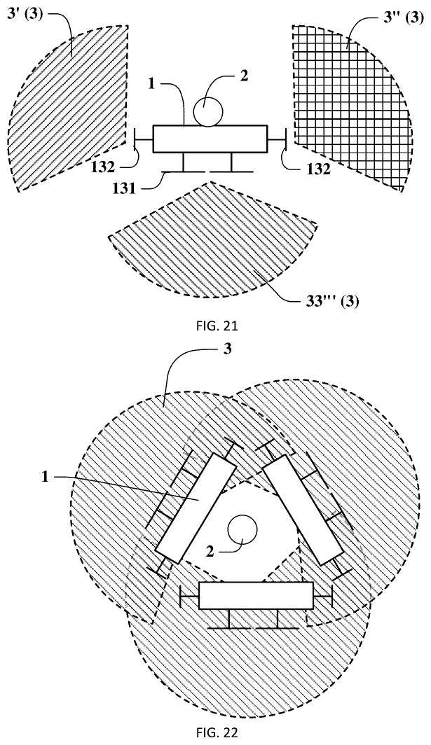

FIG. 21 is another diagram of a structure of a communication system according to an embodiment of this application. As shown in FIG. 21, in an embodiment, only one antenna 1 is disposed in one communication system. The antenna 1 includes one front radiating element array 131 and two side radiating element arrays 132 located on two sides of the front radiating element array 131. The two side radiating element arrays 132 are a first side radiating element array 132 and a second side radiating element array 132. In this solution, a networking form of a single station with a single antenna and three cells can be implemented. Specifically, a signal radiated by each radiating element array 13 may cover one cell 3, and 360° full coverage may be implemented. For example, a signal radiated by the first side radiating element array 132 may cover a first cell 3′, a signal radiated by the second side radiating element array 132 may cover a second cell 3″, and a signal radiated by the front radiating element array 131 may cover a third cell 3″. Specifically, the first cell 3′, the second cell 3″, and the third cell 3″ may be controlled by using an algorithm, so that the first cell 3′, the second cell 3″, and the third cell 3″′ each correspond to a 120° sector area, and the sector areas corresponding to the three cells 3 may be combined to implement 360° coverage. In the technical solution of this application, one antenna may be used to implement signal coverage of three cells, to reduce energy consumption of the communication system.

FIG. 22 is a diagram of a networking structure of a communication system according to an embodiment of this application. As shown in FIG. 22, in an embodiment, two or more antennas 1 may be disposed in the communication system. Signals radiated by different antennas 1 may cover a same cell 3, or may cover different cells 3. This is not limited in this application. The following describes different application scenarios by using an example in which three antennas 1 are disposed in the communication system.

For example, three antennas 1 are disposed in the communication system, and the three antennas 1 are disposed around a mounting bracket. The three antennas 1 may be specifically a first antenna 1′, a second antenna 1″, and a third antenna 1″. Cell ranges covered by signals radiated by the three antennas 1 may be configured based on a requirement.

Specifically, when the three antennas 1 are mounted, the three antennas 1 may be evenly distributed around the mounting bracket, or may be unevenly distributed around the mounting bracket. This is designed based on actual signal coverage and a channel capacity requirement. This is not limited in this application.

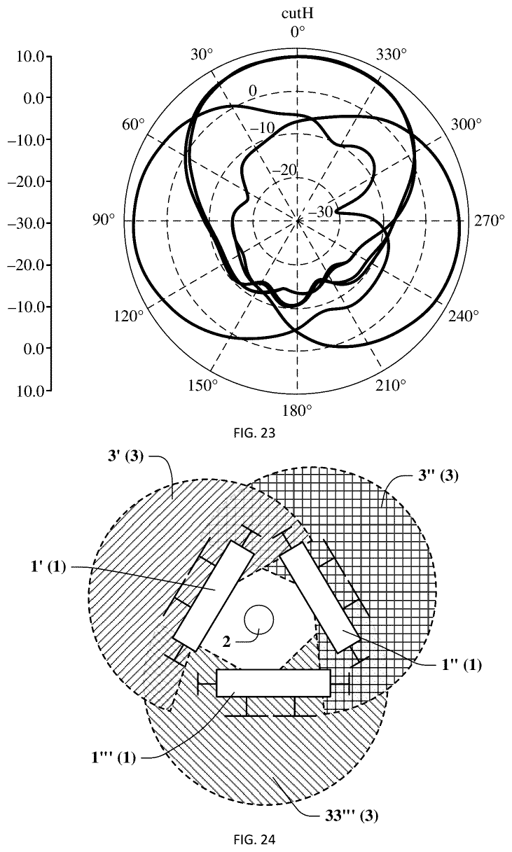

In an optional embodiment, each antenna 1 includes a front radiating element array 131 and a first side radiating element array 132 and a second side radiating element array 132 that are located on two sides of the front radiating element array 131. An antenna pattern of the communication system in this embodiment is shown in FIG. 23. It can be learned that each antenna 1 can implement 360° coverage without coverage deterioration. Therefore, different networking forms can be implemented, for example, the networking form of a single station with a single antenna and one cell shown in FIG. 20, the networking form of a single station with a single antenna and three cells shown in FIG. 21, and two networking forms of a single station with three antennas.

A first networking form in the two networking forms of a single station with three antennas is shown in FIG. 22. The first networking form may be that signals radiated by three antennas 1 jointly cover one cell 3. In this embodiment, coverage of a signal radiated by each antenna 1 may be greater than 120°, to ensure signal strength of an area corresponding to a gap between two adjacent antennas 1.

A second networking form in the two networking forms of a single station with three antennas is shown in FIG. 24. The second networking form may be that signals radiated by three antennas 1 of the communication system each cover one cell 3. For example, a signal radiated by the first antenna 1′ covers a first cell 3′, a signal radiated by the second antenna 1″ covers a second cell 3″, and a signal radiated by the third antenna 1″ covers a third cell 3″. Specifically, the first cell 3′, the second cell 3″, and the third cell 3″′ may each correspond to a sector area greater than 120°. Different cells 3 may overlap, and collaborative operation of neighboring cells 3 may be implemented by using a collaborative algorithm.

In addition to the foregoing networking forms, networking forms such as a single station with three antennas and six cells or a single station with three antennas and nine cells may be implemented. For example, each of the three antennas 1 may cover three cells 3, and a networking form of a single station with three antennas and nine cells may be implemented. This is not limited in this application.

Inter-cell interference can be further reduced by using a collaborative algorithm between cells, to implement multi-cell collaborative operation and improve system performance. In other words, an antenna 1 of each cell 3 is responsible for not only signal transmission of a user in the cell 3 but also signal transmission of a user in another cell 3. When the communication system includes the foregoing three antennas 1, because a single antenna 1 can implement 360° full coverage of a radiated signal, one or two of the three antennas 1 may be disabled based on an actual requirement, and a remaining enabled antenna 1 can also implement full coverage of a signal radiated from each cell 3. Therefore, this solution further helps reduce energy consumption required for operation of the antenna 1. In addition, if one or two of the three antennas 1 are damaged, operation of the communication system can still be ensured.

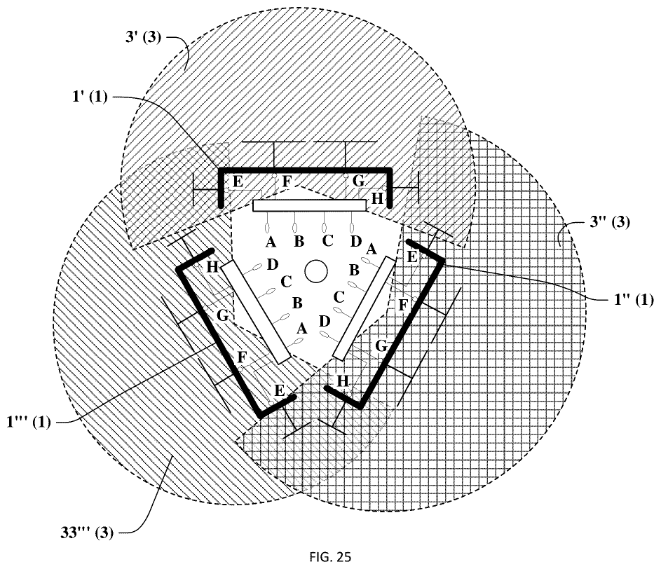

FIG. 25 is a diagram of a networking structure of a communication system according to an embodiment of this application. As shown in FIG. 25, a circuit module is disposed in each antenna 1 in the communication system. During actual application, power of an antenna 1 in each area may be adjusted based on an actual requirement, to improve a collaboration effect between different cells 3, and implement channel sharing, power sharing, and stream sharing between the cells. For example, each antenna 1 includes four radiating element arrays 13, and each radiating element array 13 has one antenna port 161. As shown in FIG. 25, if a requirement corresponding to a second cell 3″ is high, an aggregation activity is being held in an area corresponding to the second cell 3″, and a quantity of users is large, a requirement for strength of a radiated signal and a signal capacity of the antenna 1 is high. In this case, if power of 1 W is input by each of four radio frequency ports A, B, C, and D, power allocation of four antenna ports E, F, G, and H of a first antenna 1′ may be 4 W, 0 W, 0 W, and 0 W respectively, so that strength of a signal radiated by the antenna 1 in an overlapping area of a first cell 3′ and the second cell 3″ is high, and a channel capacity is large. In addition, power allocation of four antenna ports E, F, G, and H of a third antenna 1″ may be 0 W, 0 W, 0 W, and 4 W respectively, so that strength of a signal radiated by the antenna 1 in an overlapping area of a third cell 3″ and the second cell 3″ is high, and a signal capacity is large. Therefore, this solution can greatly improve strength of a radiated signal and a channel capacity of the second cell 3″.

In this embodiment, only one power allocation solution between antenna ports is listed. Certainly, in a same scenario, another allocation solution may be used based on a requirement. For example, similarly, if the requirement of the second cell 3″ is high, power allocation of the four antenna ports E, F, G, and H of the first antenna 1′ may be 2.5 W, 0.5 W, 0.5 W, and 0.5 W respectively, so that the strength of the signal radiated by the antenna 1 in the overlapping area of the first cell 3′ and the second cell 3″ is high, and the channel capacity is large. Alternatively, power allocation of the four antenna ports E, F, G, and H of the third antenna 1″′ may be 0.3 W, 0.5 W, 0.8 W, and 2.5 W respectively, so that the strength of the signal radiated by the antenna 1 in the overlapping area of the third cell 3″ and the second cell 3″ is high, and the signal capacity is large. Therefore, this solution can also improve the strength of the radiated signal and the channel capacity of the second cell 3″, and can ensure that the first cell 3′ and the third cell 3″ can also have signal coverage. The foregoing power allocation solutions are merely examples for description.

It should be noted that the foregoing embodiment is merely used as an example. The antenna in embodiments of this application may specifically include more or fewer antenna ports 161 and more or fewer radio frequency ports 162.

In a specific embodiment, to implement collaborative operation between different antennas 1, a second calibration module is connected between any two adjacent antennas 1, and the second calibration module is configured to calibrate phases and amplitudes between the different antennas 1. For ease of description, it may be considered that front radiating element arrays 131 mounted on a front mounting surface 11 of each antenna 1 form one antenna panel, and side radiating element arrays 132 mounted on each side mounting surface 12 also form one antenna panel. Inside each antenna 1, a first calibration module is used to calibrate phases and amplitudes between different antenna panels. However, between the different antenna panels, the second calibration module is used to calibrate the phases and the amplitudes between the different antennas 1. In this way, all antenna panels of the entire communication system may perform collaborative operation based on a requirement.

In a specific embodiment, all the antenna panels of the entire communication system may perform collaborative operation based on a requirement, so that the communication system may include a plurality of radiation areas, and at least one radiation area is covered by beams radiated by antenna panels of at least two different antennas 1.

Specifically, the beam radiated by the antenna panel refers to a beam within a normal range of ±60° of the antenna panel. The beam within the range has high radiation intensity, and can reliably transmit a signal to a user.

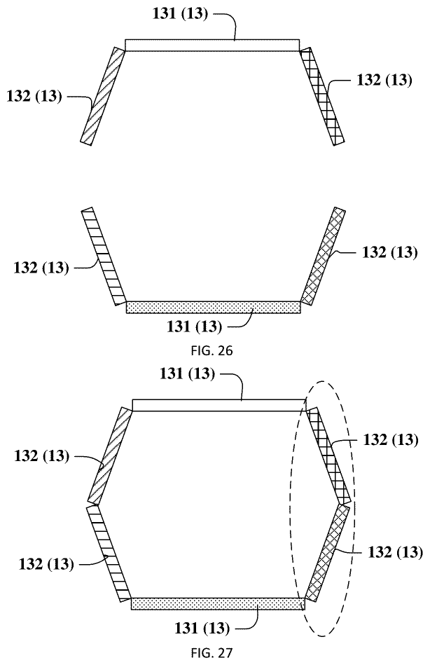

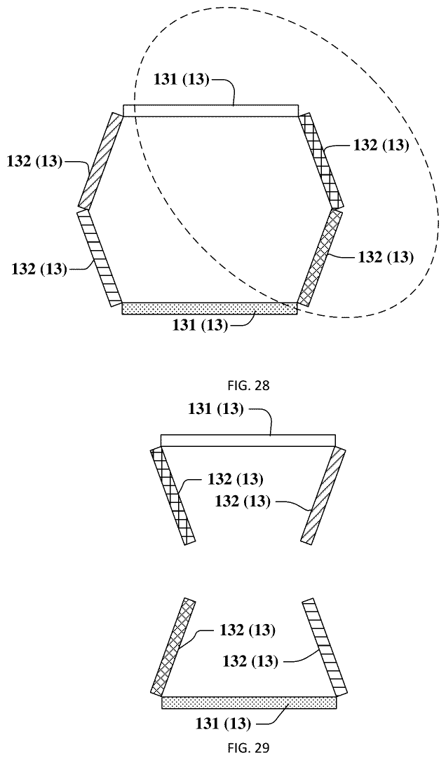

FIG. 26 is a diagram of a structure of a communication system according to an embodiment of this application. In the embodiment shown in FIG. 26, the communication system includes two antennas 1, and each antenna 1 includes three antenna panels. FIG. 27 and FIG. 28 each show a networking form of a communication system according to an embodiment of this application. The networking form is specifically a networking form of the communication system shown in FIG. 26. In a specific embodiment, all antenna panels of an entire communication system may perform collaborative operation based on a requirement. Therefore, at least one radiation area may be covered by beams radiated by antenna panels of at least two different antennas 1.

In a specific embodiment, a quantity of antenna panels forming the radiation area is not limited. For example, two antenna panels may cover one radiation area, as shown in FIG. 27; or three or more antenna panels may cover one radiation area, as shown in FIG. 28.

In addition, a quantity of radiation areas of the communication system may be greater than or equal to a quantity of antennas 1 of the communication system. For example, as shown in FIG. 27, the quantity (3) of radiation areas of the communication system is greater than the quantity (2) of antennas 1 of the communication system; and as shown in FIG. 28, the quantity (2) of radiation areas of the communication system is equal to the quantity (2) of antennas 1 of the communication system.

FIG. 29 is another diagram of a structure of a communication system according to an embodiment of this application. In the embodiments shown in FIG. 26 and FIG. 29, the communication system includes two antennas 1, and each antenna 1 includes three antenna panels. A difference lies only in that included angles between adjacent antenna panels are different. However, in the antennas 1 shown in FIG. 26 and FIG. 29, the included angles between the adjacent antenna panels are complementary.

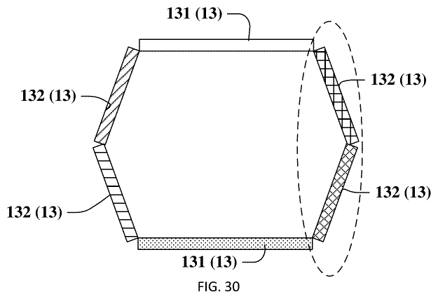

FIG. 30 shows another networking form of a communication system according to an embodiment of this application. The networking form is specifically a networking form of the communication system shown in FIG. 29. Because the foregoing included angles are complementary, the antennas 1 shown in FIG. 26 and FIG. 29 may form the networking forms shown in FIG. 27, FIG. 28, and FIG. 30. Specifically, it may be considered that the networking forms in FIG. 27 and FIG. 30 are the same, and a difference lies only in that antenna panels forming a same radiation area are different. In a specific embodiment, antenna panels covering one radiation area are adjacent or not adjacent. In the embodiments shown in FIG. 27 and FIG. 28, the antenna panels covering one radiation area are adjacent. In the embodiment shown in FIG. 30, the antenna panels covering one radiation area are not adjacent.

In addition, the radiation area of the communication system may be further in one-to-one correspondence with the antenna 1, that is, the antennas 1 may not collaborate with each other, but only a plurality of antenna arrays inside the antenna 1 collaborate with each other.

It should be noted that in this embodiment of this application, each cell may include one radiation area, or may include a plurality of radiation areas. In other words, one radiation area may form one cell, or a plurality of radiation areas may form one cell jointly.

To implement collaboration between different antenna panels, to form a radiation area, different antenna panels in a same radiation area jointly used to obtain a channel matrix. Specifically, it is assumed that the radiation area includes two antenna panels, a quantity of channels of one antenna panel is x, and a quantity of channels of the other antenna panel is y. In this application, joint channel estimation is performed on two antenna panels on a baseband side, to obtain an x+y-dimensional channel matrix, to cover one radiation area, and jointly serve one cell or one user.

In addition, joint precoding is further performed on different antenna panels in a same radiation area. A joint channel matrix is estimated to calculate a weight value of a transmit antenna of a base station antenna. This is referred to as joint precoding. That is, a codebook is calculated in a joint manner, to form an SSB broadcast channel, a CSI-RS channel, or a traffic beam.

The following describes, with reference to a specific embodiment, a manner of calculating an antenna phase when a plurality of antenna panels collaborate with each other. Both a front radiating element array 131 and a side radiating element array 132 are radiating element arrays. The communication system includes a plurality of radiating element arrays. A first radiating element array is used as a baseline. A phase of an i^{th} radiating element array is obtained based on coordinates of the first radiating element array, coordinates of the i^{th} radiating element array, an included angle between a direction of the i^{th} radiating element array and an x-axis, and a phase of the first radiating element array.

Specifically, the phase of the i^{th} radiating element array may be calculated by using the following formula:

$$\frac{2 π}{λ} \sqrt{{( x i - x 1 )}^{2} + {( z i - z 1 )}^{2}} * cos ( θ - arctan ( zi / xi ) ) + a .$$

(x1, z1) is coordinates of the first radiating element array, (xi, zi) is coordinates of the i^{th} radiating element array, and an included angle between a direction of the array and the x-axis is arctan(zi/xi). O is the included angle between the direction of the i^{th} radiating element array and the x-axis, and a unit is radian. Therefore, an included angle between an antenna direction and an antenna tangent direction is θ-arctan(zi/xi). a is a phase of the first radiating element array, and a unit is radian.

It is clear that a person skilled in the art can make various modifications and variations to this application without departing from the protection scope of this application. In this way, this application is intended to cover these modifications and variations of this application provided that these modifications and variations fall within the scope of the claims of this application and their equivalent technologies.

What is claimed is:

1. An antenna, comprising a front mounting surface, a side mounting surface, radiating element arrays, and a circuit module, wherein the radiating element arrays comprise a front radiating element array and a side radiating element array, the front radiating element array is mounted on the front mounting surface, the side radiating element array is mounted on the side mounting surface, an included angle that is between the front mounting surface and the side mounting surface and that is on a side away from the front radiating element array is a first included angle, and the first included angle is less than 180°; and one end of the circuit module is connected to an antenna port connected to the front radiating element array and an antenna port connected to the side radiating element array, another end of the circuit module is configured to connect to a plurality of radio frequency ports, and at least one antenna port is electrically connected to at least two of the plurality of radio frequency ports through the circuit module.

2. The antenna according to claim 1, wherein the first included angle is less than or equal to 90°.

3. The antenna according to claim 1, further comprising a front mounting plate and a side mounting plate, wherein the front mounting surface is located on the front mounting plate, and the side mounting surface is located on the side mounting plate.

4. The antenna according to claim 3, wherein the front mounting plate comprises a reflecting plate, and the side mounting plate comprises a reflecting plate.

5. The antenna according to claim 4, wherein at least a part of an orthographic projection of the side radiating element array on the front mounting plate is on the front mounting plate.

6. The antenna according to claim 4, wherein an edge of the front mounting plate has a first folding portion, and the first folding portion is located on a side of the front mounting plate on which the front radiating element array is mounted; and/or an edge of the side mounting plate has a second folding portion, and the second folding portion is located on a side of the side mounting plate on which the side radiating element array is mounted.

7. The antenna according to claim 1, further comprising a mounting kit, wherein the mounting kit is disposed on a side that is of the front mounting surface and that is away from the front radiating element array, the mounting kit has a connector, the connector is configured to connect to a pole, and a distance between the connector and the front mounting surface is greater than a distance between any position of the side mounting surface and the front mounting surface.

8. The antenna according to claim 1, comprising one front mounting surface and two side mounting surfaces, wherein the two side mounting surfaces are respectively disposed on two opposite side surfaces of the front mounting surface, the front radiating element array is disposed on the front mounting surface, and the side radiating element array is disposed on the side radiating surface.

9. The antenna according to claim 8, wherein the two side mounting surfaces comprise a first side mounting surface and a second side mounting surface, m columns of front radiating element arrays are disposed on the front mounting surface, n columns of side radiating element arrays are disposed on the first side radiating surface, s columns of side radiating element arrays are disposed on the second side radiating surface, and m, n, and s satisfy that m:n:s=a:b:a, wherein both a and b are integers greater than 0, and b>a.

10. The antenna according to claim 9, wherein b=2 and a=1.

11. The antenna according to claim 8, wherein the circuit module comprises a bridge, the bridge comprises an input port and an output port, the input port is connected to the radio frequency port, and the output port of the bridge is separately connected to the front radiating element array and the side radiating element array.

12. The antenna according to claim 8, wherein the antenna is an active antenna, the antenna comprises a radio frequency board and a heat sink, the heat sink is disposed on a side that is of the radio frequency board and that is away from the front mounting surface, and the front radiating element array and the side radiating element array are connected to the radio frequency board.

13. A communication system, comprising a mounting bracket and at least one antenna, wherein the antenna is mounted on the mounting bracket, wherein the antenna comprises one front mounting surface and two side mounting surfaces, the two side mounting surfaces are respectively disposed on two opposite side surfaces of the front mounting surface, a front radiating element array is disposed on the front mounting surface, side radiating element arrays comprise a first side radiating element array and a second side radiating element array, the first side radiating element array is disposed on one of the two side radiating surfaces, and the second side radiating element array is disposed on the other of the two side radiating surfaces; and
a signal radiated by the front radiating element array covers a first cell, a signal radiated by the second side radiating element array covers a second cell, and a signal radiated by a third side radiating element array covers a third cell.

14. The communication system according to claim 13, comprising at least two antennas.

15. The communication system according to claim 14, wherein a second calibration module is connected between two adjacent antennas, and the second calibration module is configured to calibrate phases and amplitudes between different antennas.

16. The communication system according to claim 14, wherein front radiating element arrays mounted on a front mounting surface of each antenna form one antenna panel, side radiating element arrays mounted on each side mounting surface also form one antenna panel, the communication system comprises a plurality of radiation areas, and at least one of the radiation areas is covered by beams radiated by antenna panels of at least two different antennas.

17. The communication system according to claim 14, wherein the communication system comprises at least two radiation areas, and the radiation areas are in one-to-one correspondence with the antennas.

18. The communication system according to claim 14, wherein both the front radiating element array and the side radiating element array are radiating element arrays, the communication system comprises a plurality of radiating element arrays, a first radiating element array is used as a baseline, and a phase of an ith radiating element array is obtained based on coordinates of the first radiating element array, coordinates of the ith radiating element array, an included angle between a direction of the ith radiating element array and an x-axis, and a phase of the first radiating element array.

19. The communication system according to claim 13, comprising three antennas, wherein the three antennas are a first antenna, a second antenna, and a third antenna.

20. The communication system according to claim 19, wherein signals radiated by the three antennas cover a same cell.
